(19) United States
(12) Patent Application Publication
(10) Pub. No.: US 2011/0187204 A1
(43) Pub. Date: Aug. 4, 2011

(54) INDUCTIVE TOUCH KEY SWITCH SYSTEM, ASSEMBLY AND CIRCUIT

(75) Inventors: Kevin Lacey, Oak Park, IL (US); James Kopec, St. Charles, IL (US); Robert Alvord, Elmwood Park, IL (US); Werner Kaps, Weiler (DE); Scot Johansen, Aurora, IL (US)

(73) Assignee: DIEHL AKO STIFTUNG & CO. KG, Wangen (DE)

(21) Appl. No.: 12/696,458

(22) Filed: Jan. 29, 2010

(51) Int. Cl. H01H 33/59

(52) U.S. Cl. 307/139

(57) ABSTRACT

An inductive touch key switch assembly and circuit are provided. The circuit optimizes signal strength and noise immunity by reducing the number of long paths through the circuit board and localizes the driver circuit to each key switch assembly sensor coil. The key switch assembly optimizes placement of the target to enable the user interfaces on domestic appliances and products having present values of front panel thickness.

### FIELD OF THE INVENTION

The instant invention relates to an inductive touch key switch and its associated control circuit, wherein the inductive touch key switch user interface is adapted for use with a control circuit having drive elements localized to each key switch.

### DESCRIPTION OF THE RELATED ART

Generally, inductive touch key switches and circuits are known. For example, referring now to FIG. 1, MICROCHIP TECHNOLOGY INC. (“MICROCHIP”) of Chandler, Ariz. has published an inductive touch key switch assembly design 10 (the “MICROCHIP Design”) that uses a magnetic coupling between a solid metal target 12 and an inductive sensing or sensor coil 14, separated from one another by a spacer layer 16. The spacer layer 16 defines a cavity or pocket into which the solid metal target 12 can flex when pressed, thus changing the proximity to, and the field around, the sensor coil 14, which is mounted to, printed on and/or etched into a printed circuit board PCB 19. More particularly, pressing the inductive key switch defined on a front panel 18 causes the coupling between the target 12 and sensor coil 14 to change, thus indicating a key press. The front panel 18, also called the top key switch layer or fascia, can be the outermost skin of the product or domestic appliance of which the keyboard is a part. The MICROCHIP Design suggests that materials of choice for a combined fascia layer/target are copper, aluminum, brass, stainless steel and mild steel, but a target in accordance with the design could also be made from gold and/or silver, so long as the material permits a physical deformation of the target over the sensor coil. Specific target embodiments disclosed in the MICROCHIP Design include a copper lamination and a self-adhesive copper label stuck to the underside of the fascia. The MICROCHIP Design states that, generally, the target 12 should be the size and shape of the sensor coil 14.

What is needed is an improved target design for use with an inductive touch key switch system.

Additionally, in accordance with the MICROCHIP Design, a microcontroller is provided to periodically poll various sensors by measuring the impedance of a sensing coil. If the impedance of the sensing coil has changed, then the microcontroller determines if the shift in impedance is sufficient to qualify as a user's press. In the MICROCHIP Design, the individual sensing coils (i.e., one for each switch) are connected, by a single common connection, to a “reference coil” that acts as a reference inductor, allowing a ratio-metric measurement which removes several sources of drift. As shown in FIG. 2, the inductive touch circuit of the MICROCHIP Design utilizes a single driver circuit to drive each of the sensing coils, each of which is tied through a common connection to the reference coil.

However, in many applications, the outer material of a key switch (the fascia) is made from a relatively thick piece of stainless steel, for example, 0.032-0.036 inches thick. However, using the calculations taught in the MICROCHIP Design, to produce a 0.010 mm movement of an inductive key switch having a target fascia/target thickness of 0.036 inches under 1.1 lb force key press would require a sensing coil having a diameter of 2.15 inches. Such a sensing coil diameter would be impractical for the landscape of the device keyboard, i.e., requiring a key spacing of more than 2 inches. Also, it was found that, with such materials, a drive current needed to be sufficiently high so as to induce eddy currents in the metal. However, higher drive currents in the large drive loops on the PCB can cause crosstalk and loss of signal strength in the circuit. Additionally, the circuit loops can pick up signals from external fields (i.e., large loops on the PCB layout pick up noise signals). However, the use of “reference coils” in the MICROCHIP Design forces the inclusion of large current loops in the PCB layout, as every sensing coil in the keyboard must pass its current to the reference coil. This increased noise/decreased signal strength problems are even further exacerbated when a keyboard is long, rather than of a small, square shape.

The MICROCHIP Design suggests that, as an alternative solution, the reference coil can be omitted and software can be provided to compensate for drift. However, the MICROCHIP Design specifically discloses that such software can become complex and can significantly increase the burden on the microcontroller, whereas the inclusion of the reference inductor on the board is minimal and, therefore, the MICROCHIP Design specifically states that omitting the reference coil is not recommended, once the increase in software complexity is considered.

What is needed is an inductive touch key switch and circuit that improves noise immunity and signal strength, without requiring the addition of the complex software described in connection with the MICROCHIP Design.

### SUMMARY OF THE INVENTION

It is accordingly an object of this invention to provide an inductive touch key switch and circuit that overcomes the disadvantages of the prior art. In one particular embodiment of the invention, an improved inductive touch key switch is provided. In another embodiment of the invention, an inductive touch key switch circuit that does away with the reference inductor without requiring the addition of complex software is provided.

Although the invention is illustrated and described herein as embodied in an inductive touch key switch assembly and circuit, it is nevertheless not intended to be limited to the details shown, since various modifications and structural changes may be made therein without departing from the spirit of the invention and within the scope and range of equivalents of the claims.

The construction of the invention, however, together with the additional objects and advantages thereof will be best understood from the following description of the specific embodiments when read in connection with the accompanying drawings.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is a cross-sectional view of an inductive touch sensor assembly in accordance with the prior art;

FIG. 2 is a block diagram of an inductive touch circuit in accordance with the prior art;

FIG. 3 is a circuit diagram of an inductive touch key switch circuit in accordance with one particular embodiment of the present invention;

FIG. 4 is a cross-sectional view of an inductive touch key switch assembly in accordance with one particular embodiment of the instant invention;

FIGS. 5-7 are cross-sectional views of inductive touch key switch assembly in accordance with other particular embodiments of the instant invention;

FIG. 8A is an isometric view of a disc used as a target in accordance with one particular embodiment of the instant invention;

FIG. 8B is a side plan view of the disc of FIG. 8A;

FIG. 9A is an isometric view of a legged disc used as a target in accordance with one particular embodiment of the instant invention;

FIG. 9B is a side plan view of the legged disc of FIG. 9A;

FIG. 10 is a view of a dome or cap shaped target in accordance with another embodiment of the instant invention;

FIG. 11 is an isometric view of a rectangular target in accordance with another embodiment of the present invention;

FIGS. 12-15 are cross-sectional views of inductive touch key switch assembly in accordance with further particular embodiments of the instant invention;

FIG. 16 is a top plan view of one particular embodiment of a multi-leaf target in accordance with another embodiment of the instant invention;

FIG. 17 is a top plan view of the metal deposition layer of a sensor coil in accordance with one particular embodiment of the present invention;

FIG. 18 is a perspective, exploded view of the metal deposition layers of a multi-level coil in accordance with one particular embodiment of the present invention;

FIG. 19A is a partial, cut-away, side plan view of an inductive touch keyboard in accordance with one particular embodiment of the invention;

FIG. 19B is a partial, exploded view of a portion of the keyboard of FIG. 19A;

FIG. 20A is a perspective view taken from the top of one particular embodiment of a frame for use in the keyboard of FIG. 19A;

FIG. 20B is an enlarged partial top plan view of a frame including key switch members in accordance with one particular embodiment of the invention;

FIG. 21A is a top plan view of a key switch member in accordance with one particular embodiment of the invention;

FIG. 21B is a perspective view, taken from the top, of the key switch member of FIG. 21A; and;

FIG. 21C is a perspective view, taken from the bottom, of the key switch member of FIGS. 21A and 21B;

FIG. 22 is a top plan view of one possible PCB layout for each inductive touch key switch assembly in accordance with one particular embodiment of the present invention.

### DETAILED DESCRIPTION OF THE PREFERRED EMBODIMENTS

An inductive touch key switch assembly and circuit are provided herein, which, under certain circumstances, can be used to improve both the signal strength and the noise immunity of the instant invention over that of the MICROCHIP Design.

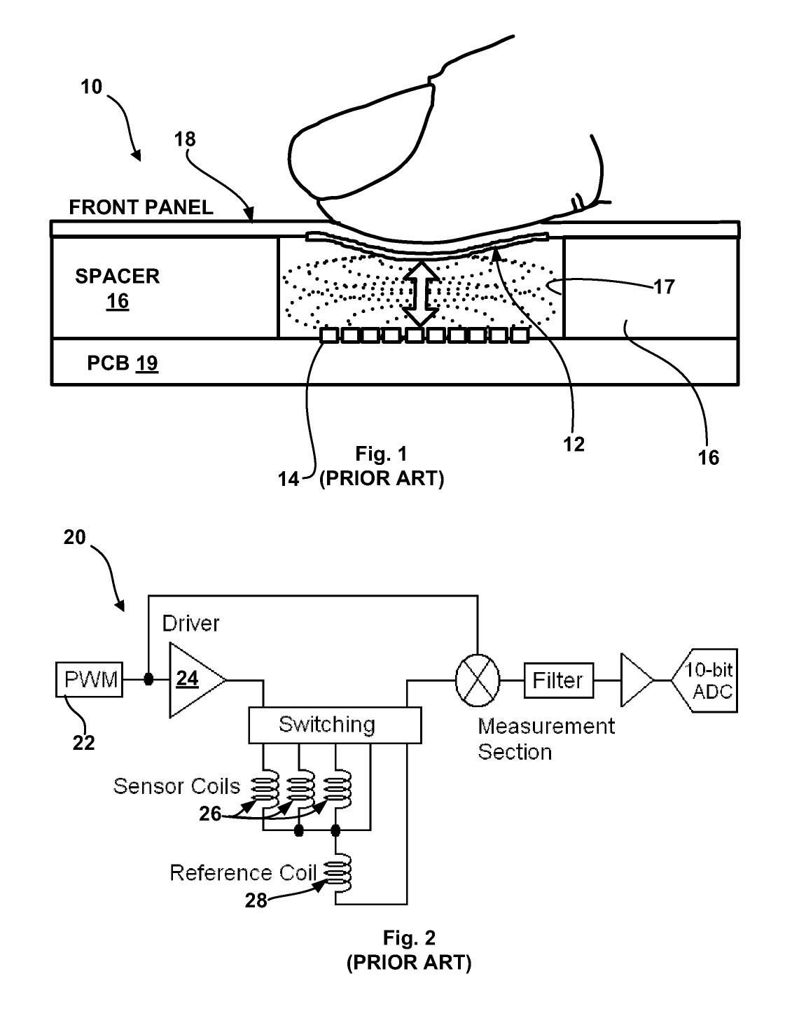

Referring more particularly to FIG. 2, there is shown a block diagram of a prior art inductive touch key switch system 20 in accordance with the teachings of the MICROCHIP Design. In order to measure the impedance of an individual sensor or sensing coil 26, the system 20 produces a pulse at the pulse width modulator (PWM) 22, which is converted into a drive pulse by the driver 24 that is used to excite, in turn, each individual sensor coil 26. This produces a pulsed voltage across the excited sensor coil 26 that is proportional to both the current and the impedance of the coil 26. The pulsed voltage from the sensor coil 26 is further processed and analyzed to determine whether a shift in impedance has occurred, indicating a user's touch. As shown in FIG. 2, each of the sensor coils 26 are connected at one end to a single common connection with a reference coil 28. As described hereinabove, the connection to such a reference coil forces the creation of long paths in the PCB layout that pick up noise and decrease signal strength, especially in long keyboards.

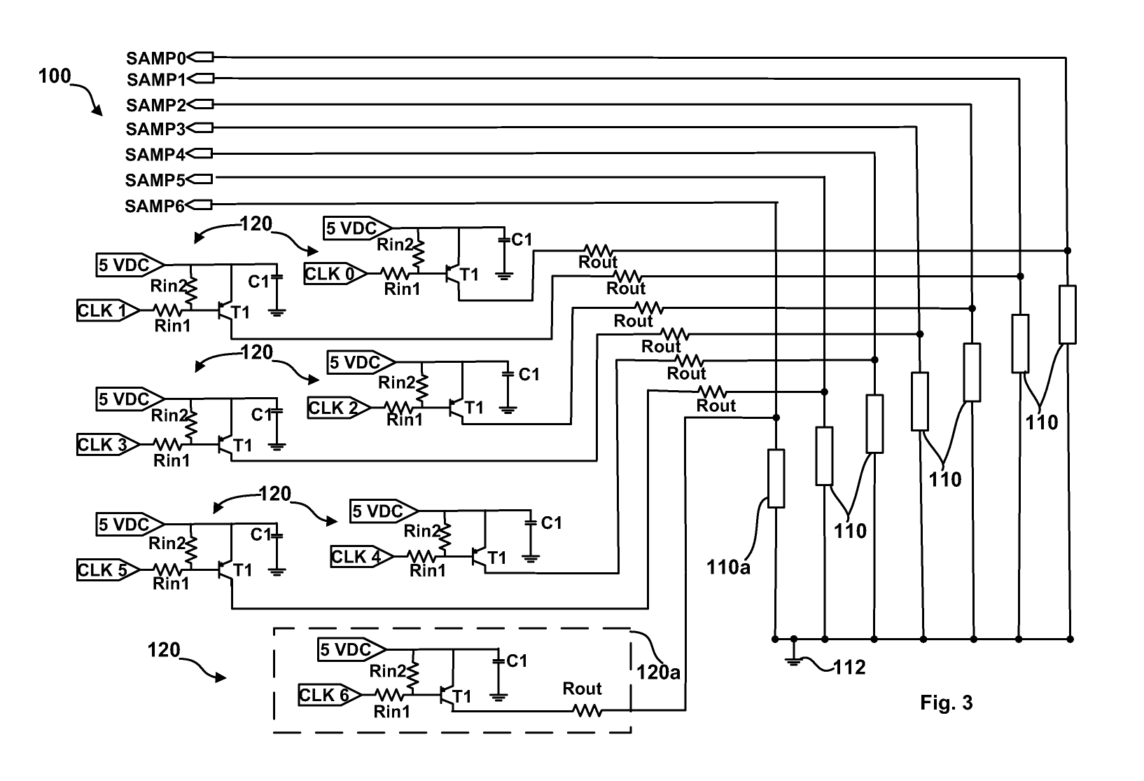

Referring now to FIG. 3, there is shown one particular embodiment of an inductive touch key switch circuit 100 of the present invention that provides improved noise immunity and signal strength transmission. In particular, the number of long, noisy paths inherent in the prior art system are greatly reduced. As can be seen from the circuit of FIG. 3, each of the sensor coils 110 of the system 100 is tied at the common connection directly to ground 112 (i.e., and not through any other serially connected circuit element), and not to a reference coil, thus obviating the need to extend a path from each sensor coil to a common reference coil. Thus, no energy goes to the reference coil, thereby reducing the ratio change when a key press is detected. If desired, in one particular embodiment of the invention software filtering is added to compensate for drift, in place of the omitted reference coil.

Further, the circuit 100 also eliminates long paths from a common driver circuit to each sensor coil 110 by providing individual drive or driver circuits 120 for exciting each coil 110. More particularly, each of the driver circuits 120 are provided local to (i.e., in close proximity to) the sensor coil 110 that it drives. For example, the driver circuit 120a is located on the PCB near the sensor coil 110a. Similarly, the remaining individual driver circuits 120 are located on the PCB near the respectively connected sensor coil 110, driven by the individual driver circuit 120. For example, FIG. 22 shows a representative metal layer 160 of a PCB layout in accordance with one particular embodiment of the present invention. In the metal layer 162, the metal forming the sensor coil 162 is laid on the PCB proximal to the metal tracks 166 and contacts or pads 164 for the elements of the drive circuit (i.e., a drive transistor, input resistor(s), output resistor(s), etc.). In particular, for each sensor coil 162 of a keyboard, the metallization for the contacts for the drive circuit associated with that sensor coil 162 is located, at most, a few millimeters away from the outermost winding of the sensor coil 162, and thus, can shorten the lead lengths between a drive circuit and the sensor coil 162 that it drives.

As illustrated in FIG. 3, each of the plurality of driver circuits 120 includes its own drive transistor T1 and resistor and capacitor elements used to define the drive current. In one particular embodiment of the invention, each of the drive circuits 120 includes at least a drive transistor T1, a first input resistor Rin1, connected between the base of the transistor T1 and a clock input for the respective driver circuit 120, a second input resistor Rin2, connected between the base of T1 and a DC power supply, an output resistor Rout and a capacitor C1. For purposes of example only, in one particular embodiment of the invention, Rin1 is 470 ohms, Rin2 is 100 ohms, Rout is 270 ohms, C1 is 1 μF and the power supply is 5 Volts DC. The value of the inductors 110 are chosen based on a number of factors, including the outer radius of the coil, the number of turns in the coil and the depth of the coil. Each sensor coil 110 is periodically sampled, via a sampling output shown in FIG. 3, by a microcontroller or microprocessor (not shown). Note that, although the transistor T1 is illustrated as being a pnp transistor, this is not meant to be limiting, as the circuit can be adapted to use an npn transistor.

As shown in FIG. 3, each sensor coil 110 of the instant embodiment is driven by only one driver circuit 120, and conversely, each driver circuit 120 drives only one associated sensor coil 110. This prevents the need for routing higher currents around the PCB (i.e., from a central, common driver circuit to each individual sensor coil). The localization of each of a plurality of driver circuits to its one associated sensor coil results in a small current loop through the sensor coil of each key assembly, without much current/noise radiating outside of the coil. Thus, the less current/noise radiated outside the coil, the less can be picked up by other sensor coils. Eliminating the reference coil and moving the driver circuit local to each coil/key assembly allows for better use of the sensing current and energy, as well as making the loop area smaller to reduce the pick-up from external noise fields (as each coil can act as an antenna to external fields). These circuit changes also result in less connections being routed across the PCB. Since keyboards for appliances tend to be narrow, this also helps to reduce their complexity and permits the fabrication of the assembly using fewer layers in the PCB design than traditional assemblies. This, resultantly, reduces the cost for producing the assembly.

Since, in the above-described embodiment of the present invention, nearly all external fields will form a uniform field localized to the individual coil/key assembly, noise pick-up by the coil can be further reduced by adding a shorted turn outside of the coil in the PCB foil. This will tend to reduce some of the signal strength, but since it is outside of the coil area and the coil induced field is concentrated near the coil pattern, it does not make a large reduction in signal strength. The shorted turn, however, will reduce uniform external fields, since they come from outside of the coil pattern.

Additionally, if desired, noise pick-up by the sensor coil can be further reduced by adding turns outside of the sensor coil, as an extension of the sensor coil, but of reverse direction. See, for example, FIG. 17, wherein the turns 510 of the sensor coil 500 turn in a first direction, but reverse at the turn portion 515 to include a plurality of turns 520 in the reverse direction. The use of such extra turns 520 will reduce field strength such that, to external fields, the loop area of the sensor coil minus the loop area of the reverse direction turns results in pick-up by (N coils—x reverse turns)². Note that only a few large reverse turns will equal the same loop area of many small turns in the coil.

Referring now to FIG. 18, there is shown a further embodiment of a multi-level or multi-layer sensor coil 530 that can be used as the sensor coil in a system in accordance with the instant invention. In particular, the multi-layer sensor coil 530 includes two individual sensor coils 540, 550 that overlay one another on the surface of the PCB (not shown), and which share commonly connected input 542, 552 and output contacts 544, 554. In particular, the coil 550 is wound in an opposite direction to that of the coil 540, and overlays the coil 540 on the PCB. Both input contacts 542 are connected to a sense input (shown, for example, in FIG. 3) of a microcontroller or microprocessor (not shown), which is programmed to evaluate the measurements taken across the sensor coil 530. The output contacts 544 and 554 are connected to a common reference potential such as ground The multi-layer coil provides for a greater field strength and better eddy currents, which result in a better signal back when movement of the target occurs. The PCB can further include offset vias to avoid blind vias and to help keep down the cost down. Note that, although two coils are shown in the exemplary illustration of FIG. 18, this is not meant to be limiting, as even more layers of coils can be provided, if desired. However, it should be understood that increasing the number of layers of coil in the sensor coil 530 correspondingly decreases the spacing between the uppermost surface of the sensor coil 530 and the target portion of the key switch, due to the increased thickness of the layers on the PCB. A corresponding adjustment to the spacing between the uppermost coil layer and the target can be made to accommodate for the increased layer height on the PCB, if desired.

Another benefit of localizing the driver circuits is that, if desired, the driver circuits 120 can be configured to permit key to key variations in drive strength. For example, differently sized keys (and their associated coils) may need different levels of signal strength. The driver voltage can be varied from one sensor coil/key assembly to another by a fixed value. Alternately, if desired, the driver voltage can be varied from one sensor to another as a software variable using an adaptive algorithm.

A further advantage to the localization of the driver 120 to the location of the associated sensor coil 110 is that the delay of the drive pulse can be optimized to get all useful signals into the detector, as compared to a synchronous detector system. In particular, the delay can be much improved by moving the drive transistor and sense resistor to the coil location, as previous drive pulse delay times were affected by temperature and part variation.

Additionally, in one particular embodiment of the invention, noise was further reduced by adding coil layers in the PCB design. For example, in accordance with the present embodiment, coils can be stacked in double sided PCBs. In one very particular embodiment, four layers of coils were stacked in a four layer PCB by offsetting the via, to avoid hidden vias.

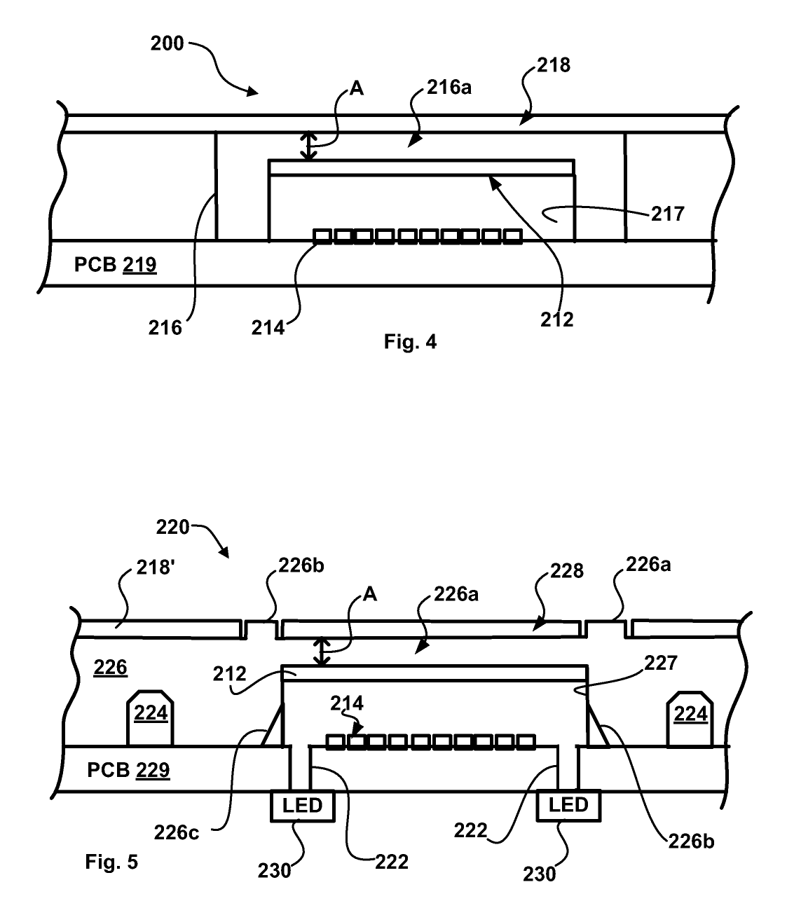

Referring now to FIG. 4, there will be described an inductive touch key switch assembly 200 providing improved signal strength and mechanical stability in an inductive touch key switch system in accordance with one particular embodiment of the present invention. The key switch assembly 200 of the instant embodiment is disposed below a portion of the front panel or fascia 218 (i.e., the front panel of the keyboard, product and/or domestic appliance) defining a key switch of the user interface. In one particular example, the front panel 218 and thus the user interface, is a thin stainless steel plate. However, in contrast to the prior art key switch assembly illustrated in FIG. 1, the target 212 of the key switch assembly 200 is not adhered to the underside of the fascia 218, but rather, is supported by a frame 216 disposed between the fascia 218 and the PCB 219.

The frame 216 is formed as a bracket or pocket defining a space or cavity 217 around the sensor coil 214. Most preferably, the frame 216 is a separate, stand-alone piece made of plastic and includes a support bracket 216 surrounding the sensor coil 214, at the top of which is a bridging section 216a that passes over the sensor coil 214 and under the fascia 218, adjacent to, and in contact with, the underside of the fascia 218 at a location defining a key switch on the user interface of the front panel 218. A metallic target 212 of the instant embodiment is adhered to the underside of the bridging section 216a, in the cavity 217, above the sensor coil 214. The support bracket 216 can be made as a frame (i.e., four legs or four walls, etc.) or can be in the shape of a ring covered by the bridging section 216a. This frame can be connected to the PCB 216 by screws, heat staked connectors, or other known connection methods. In the instant embodiment, the bridging section 216a is designed to be very thin plastic, so that flexure of the fascia 218 will result in flexure of the bridging section 216a. In one particular example, the thickness “A” of the bridging section 216a is 0.8 mm.

Upon flexure of the fascia 218 and, resultantly, the bridging section 216a, the metallic target 212 on the underside of the bridging portion is additionally flexed, thus changing between the target 212 and the sensing coil 214, indicating a key switch press. Thus, in the instant embodiment, the target 212 is supported by a structure disposed between the front panel fascia 218 and the PCB 219, and is not directly adhered to the underside of the front panel fascia 218.

Rather, as noted above, the target 212 of the key switch assembly 200 is adhered to the underside of the bridging section 216a, to bring the target 212 into the desired relationship to the sensor coil 214. In one particular embodiment of the instant invention, the target 212 is applied to the underside of the bridging section as part of a heat stamping process. Alternatively, if desired, the target 212 can be applied to the underside of the bridging section 216a by printing the target directly on the backside of the fascia to create a metal surface above the sensor coil. For example, in accordance with the instant embodiment, a heat stamped foil or a conductive printing material can be applied to the frame 216 by an appropriate process (i.e., heat stamping, printing, etc.). The heat stamping or printing of the target 212 on a surface of the frame 216, rather than the fascia 218, can be especially useful in applications where adjacent lighting is needed and/or curved surfaces are used.

In one particular embodiment of the invention, a portion of the front panel 218 defines a user interface or keyboard for a product or domestic appliance. Using a heat stamping process, a metal foil is stamped onto the internal surface of the plastic bracket or pocket. In the instant embodiment, the foil is desirably between 0.05 mm and 0.1 mm in thickness. Thus, in the instant embodiment, the traditional PCB based keypads are replaced by a heat stamped foil or printed conductive layer supported by a separate bracket.

Alternately, as described above, a printing process can be used to print a conductive material onto the underside of the bridging section 216a. The thickness of the printed material would be similar to that for the heat-stamped foil, i.e., most preferably between 0.05 mm and 0.1 mm.

Referring now to FIG. 5, there is shown another embodiment of a key switch assembly 220 in accordance with the present invention. The key switch assembly 220 is similar to the key switch assembly 200 of FIG. 4, but is directed towards a user interface including key switches having some kind of lighted indicia, such as words, light rings and/or other lighted indicators, but which include an opaque plate. The key switch assembly 220 includes a target 212 mounted to the bridging section 226a of a frame 226 in a particular plane relative to a sensor coil 214. As with the previous embodiment, flexure of the key switch fascia 228 results in the flexing of the bridge section 226a, which changes the coupling between the target 212 and the sensor coil 214, indicating a key press of the key switch fascia 228. However, in the instant embodiment, the frame 226 of the instant embodiment is made of a clear or other light transmissive plastic, so that light emitted from a light source can be transmitted to the ring, words or indicia on the user interface. Although any suitable type of light source may be used (i.e., incandescent, electroluminescent, etc.) in connection with the present invention, in one preferred embodiment the light source includes light emitting diodes (LEDs) 230 mounted to the underside of the PCB 229.

In one particular embodiment of the invention shown in FIG. 5, the plastic frame includes a light transmissive ring portion 226b, which surrounds an opaque key switch fascia 228. Alternately, or in addition thereto, the key switch fascia 228, itself, can have cutout portions, such as words or other indicia, that are intended to be lighted. Light emitted by the LEDs 230 are used to illuminate the ring and/or indicia, as follows. Light from the LEDs 230 pass through the PCB 229 via holes 222 in the PCB 229 located adjacent to the light emitting face of the LEDs. The holes 222 open into the cavity 227 formed in the frame between the target 212 and the sensor coil 214. The light emitted directly into the cavity 227, as well as that light reflected from the metal target 212, is transmitted by the frame 226 to the light ring portions 226b of the frame 226, and/or to any indicia or words on the fascia 228 and/or the front panel 218′. If desired, the frame 226 can optionally include facets 226c particularly located to direct and concentrate light emitted by the LEDs 230 into the cavity 227 onto the light ring portions 226b. Additionally, if desired, the frame 226 can include opaque or non-light transmissive portions 224, to block the light emitted in connection with one key switch assembly from being transmitted to another key switch assembly. In one particular embodiment of the instant invention, the PCB 226 located in the cavity 227 has an applied white coating, to even further reflect light from the cavity 227 into the light transmissive frame 226.

As with the key switch assembly 200, the target 212 of the key switch assembly 220 can be applied to the frame 226 in a variety of ways including, but not limited, heat stamping the target 212 to the frame 226 and/or printing the target 212 to the frame 226 using a conductive ink. Note that, if desired, the target 212 can also be made as a metal disc or foil that is adhesively applied to the underside of the bridging section 226a, without deviating from the spirit of the instant invention.

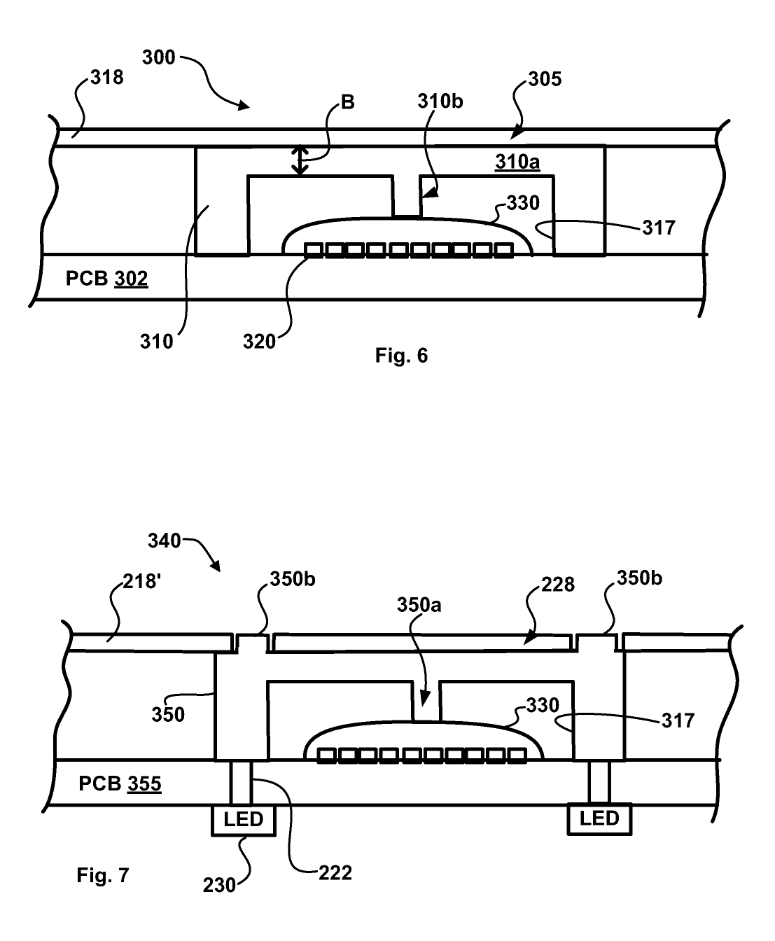

Referring now to FIG. 6, there is shown a further embodiment of a key switch assembly 300 for an inductive touch key switch in accordance with the present invention. The key switch assembly 300 includes a frame 310 disposed between the PCB 302 and the front panel 318 of the user interface of an appliance, similar to the frame 216 described in connection with FIG. 4. The frame 310 of the assembly 300 includes a bridging section 310a, located adjacent to, and in contact with, the underside of the front panel 318 at a location defining a key switch on the front panel 318. The bridging section is preferably made of a thin plastic material, having a thickness “B” that permits it to flex in response to flexure of the front panel 318. In one particular embodiment, the dimension “B” is 0.8 mm.

The frame 310 additionally includes a push pin or boss 310b extending from the middle of the bridging portion 310a, towards the sensor coil 320. In the instant embodiment of the invention, the target 330 is in communication with the distal end of the boss 310b and has a circumference that is greater than the circumference of the sensor coil 320, thus circumscribing the sensor coil 320. As can be seen, flexure of the front panel 318 above the bridging section 310a will cause the push pin 310b to push a portion of the target 330, thus flexing the target 330 and, resultantly, changing the coupling between the target 330 and the sensor coil 320, indicating a key switch press. In the present embodiment of FIG. 6, the target 330 is formed as a dome-shaped cap, as shown more particularly in FIG. 10.

Note that other shapes of target can be used in connection with the frame 310 to achieve the same results. For example, FIGS. 9A-9B show a legged “disc” 332 that can be surface mounted (via the extending leg portions) on the PCB 302, in place of the target 330 of FIG. 6, wherein flexure of the front panel 318 over the frame 310 causes the boss 310b to flex the legged disc 332, thus changing the coupling between the target 332 and the sensor coil 320, indicating a key switch press has occurred. The legged disc 332 of FIGS. 9A and 9B can be formed by chemically etching and/or stamping of the metal to be used as the target.

Similarly, referring now to FIGS. 6 and 11, instead of the dome or cap shaped target 330, a target 334 in the shape of a square or rectangle (i.e., “box-shaped”) can be placed over the sensor coil 320 and activated by the boss 310b upon flexure of the front panel 318 over the frame 310.

Referring now to FIG. 7, there is shown a further embodiment of a key switch assembly 340 utilizing a frame 350 having a boss 350a to transmit the flexure of the key switch fascia 228 to the PCB board mounted target 330, wherein light from a light source, LEDs 230 in the current embodiment, pass through holes 222 in the PCB 355. In the instant embodiment, the frame 350 is made from a light-transmitting material, such as a clear plastic. The frame 350 is, therefore, aligned with the holes 222, to cause light to show from the ring portions 350b, as well as through any words or indicia cut into the key switch fascia 228. Note this is not meant to be limiting, as other arrangements of the LEDs, holes 222 and frame 350 can be implemented in accordance with the present invention. For example, the LEDs 230 and holes 222 can be arranged to illuminate the central cavity 317 of the frame 350, and through this, the frame 350 and ring portions 350b, in the same manner as described in connection with the frame 226 of FIG. 5.

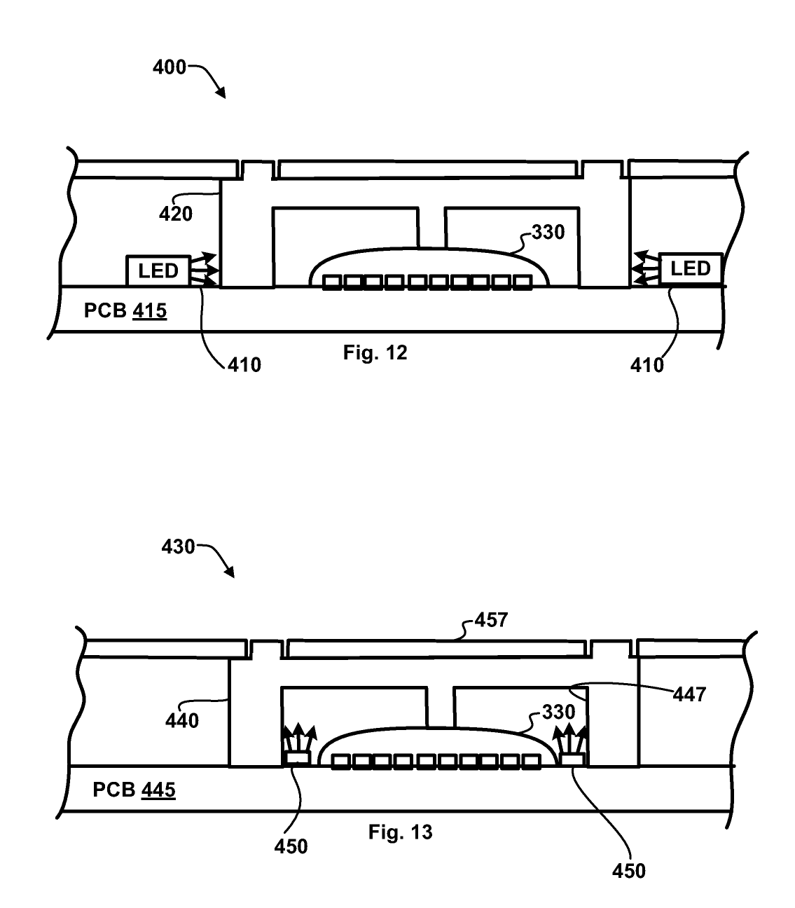

Additionally, if desired, the LEDs 330 can be replaced with LEDs mounted on the front side of the PCB 355. Referring now to FIGS. 12 and 13, there are shown two further lighted key switch assemblies 400, 430, respectively, in accordance with additional embodiments of the instant invention. More particularly, FIG. 12 shows an key switch assembly 400 wherein the LEDs 410 are mounted on the front side of the PCB 415, with their light emitting faces pointed towards the sidewalls of the frame 420. In FIG. 13, the LEDs 450 are surface mounted on the PCB 445 within the cavity 447 of the frame 440, with their light emitting faces being directed towards the front panel 457. It can be seen from the foregoing that other configurations of a lighted key switch assembly can be made using a light transmissive frame in communication with a target in accordance with the present invention.

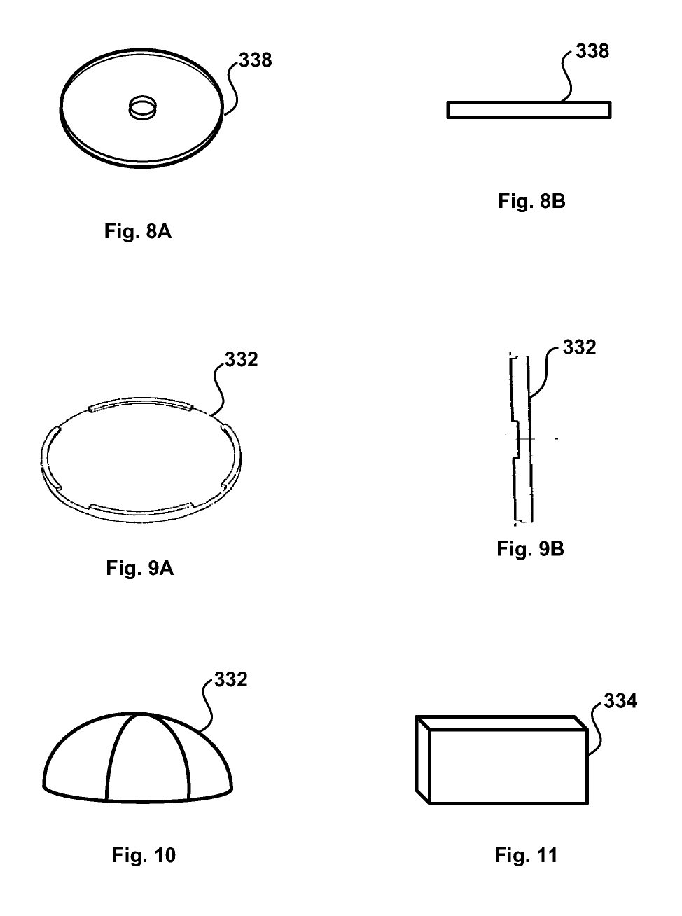

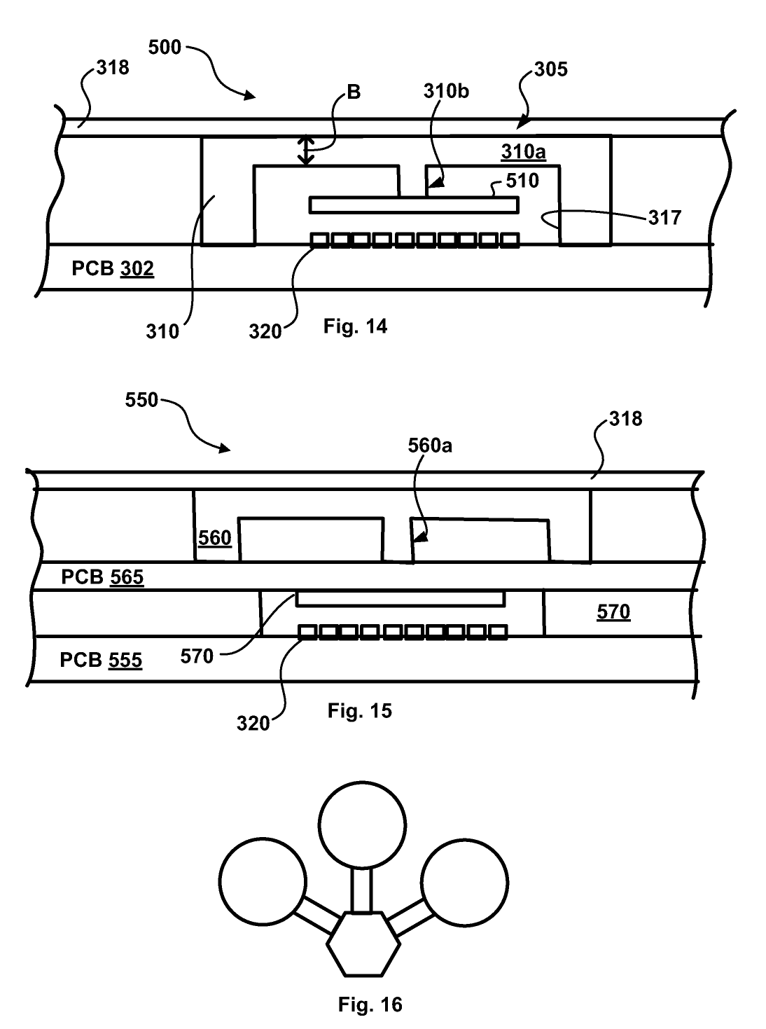

Referring now to FIG. 14, there is shown another embodiment of a key switch assembly 500 in accordance with the present invention. The key switch assembly 500 is similar, in many respects, to the key switch assembly 300 of FIG. 6. However, instead of using a surface mounted target sandwiched between the boss and the PCB, as with the key switch assembly 200, the instant embodiment uses a floating target 510 secured to the boss 310b. As such, flexure of the bridging portion 310a, rather than causing flexure of the target 510, brings the target closer to the sensor coil 214, thus changing the field of the sensor coil 214 and indicating a key press. Although any of the targets described herein in connection can be used as the target 510, in one particularly preferred embodiment, the target 510 is a cut or stamped disc, such as the disc 338 illustrated in FIGS. 8A and 8B, herein. The diameter of the disc 338, 510 can be chosen, as desired, but is preferably equal to or greater than the diameter of the sensor coil 320. It can also be seen that the floating target 510 of FIG. 14 can be used in a lighted key assembly, in accordance with the teachings herein. For example, the floating target 510 can replace the surface mounted target 330 in the key switch assembly 340 of FIG. 7, or in any other embodiment described herein.

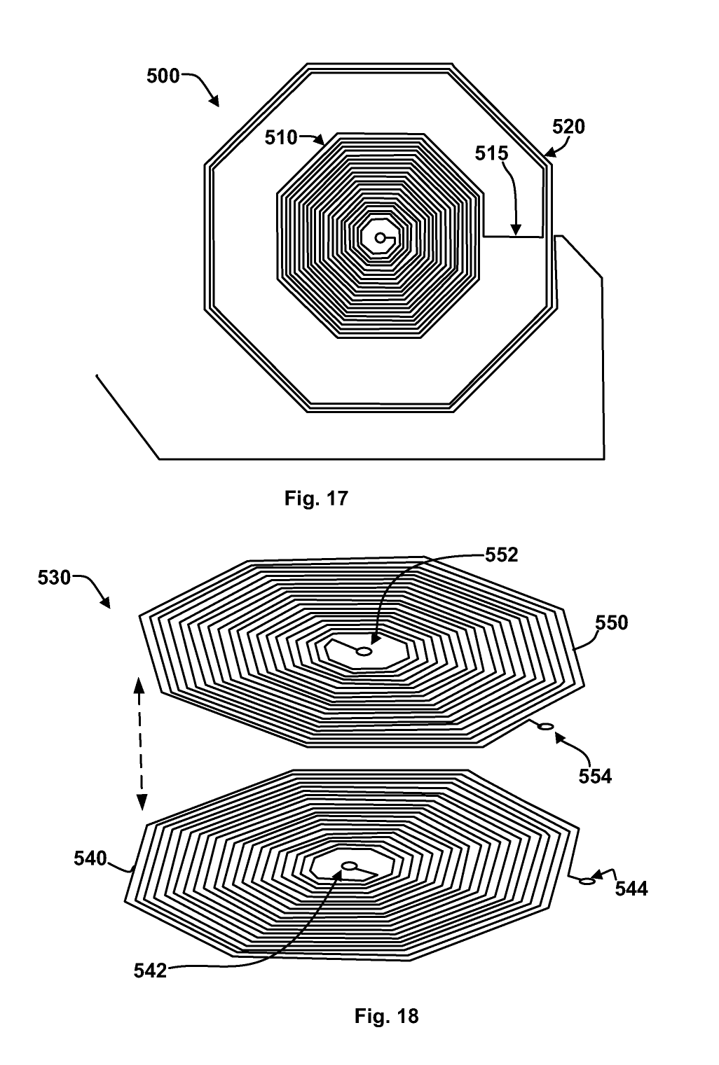

Additionally, in accordance with the teachings made in connection with FIG. 14, multiple floating targets of multiple key switch assemblies can be implemented using a single, multi-leaf floating target, such as that shown in FIG. 16, if desired.

Referring now to FIG. 15, there is shown a further embodiment of an inductive touch key switch assembly 550 in accordance with the present invention. In the present embodiment, instead of being disposed between, and in communication with, the PCB 555 and the front panel 318, the frame 560 is disposed between a ground plane PCB 565 and the front panel 318, which is disposed above the PCB 555 supporting the sensor coil 320. The ground plane PCB 565 is separated from the PCB 555 by a spacer 570, which includes a circular cut-out above the sensor coil 320, thus creating a cavity or chamber above the sensor coil 320. The frame 560 is supported on the ground plane PCB 565 by its outer wall portions over solid portions of the spacer layer, thus supporting the frame 560 when a key switch indicated on the front panel 318 above the assembly 550 is pressed. The frame additionally includes, extending from the middle portion thereof, a boss 560a, in contact with a portion of the ground plane PCB 565. Flexure of the front panel 318 over the boss 560a causes the boss 560a to flex the PCB 565. The portion of the PCB 565 disposed below the boss 560a includes a metal target 570 disposed on the bottom side thereof, adjacent the sensor coil 320. Thus, flexure of the front panel 318 is transmitted, by the frame 560 to the target 570, which changes the coupling between the target 570 and the sensor coil 320, indicating a key switch located above the assembly on the user interface has been pressed. In one particularly preferred embodiment, the target 570 is either printed or heat-stamped onto the undersurface of the PCB 565. Note that other methods of depositing the target 570 onto the PCB 565 can be used, including all known methods for providing metallization of a PCB.

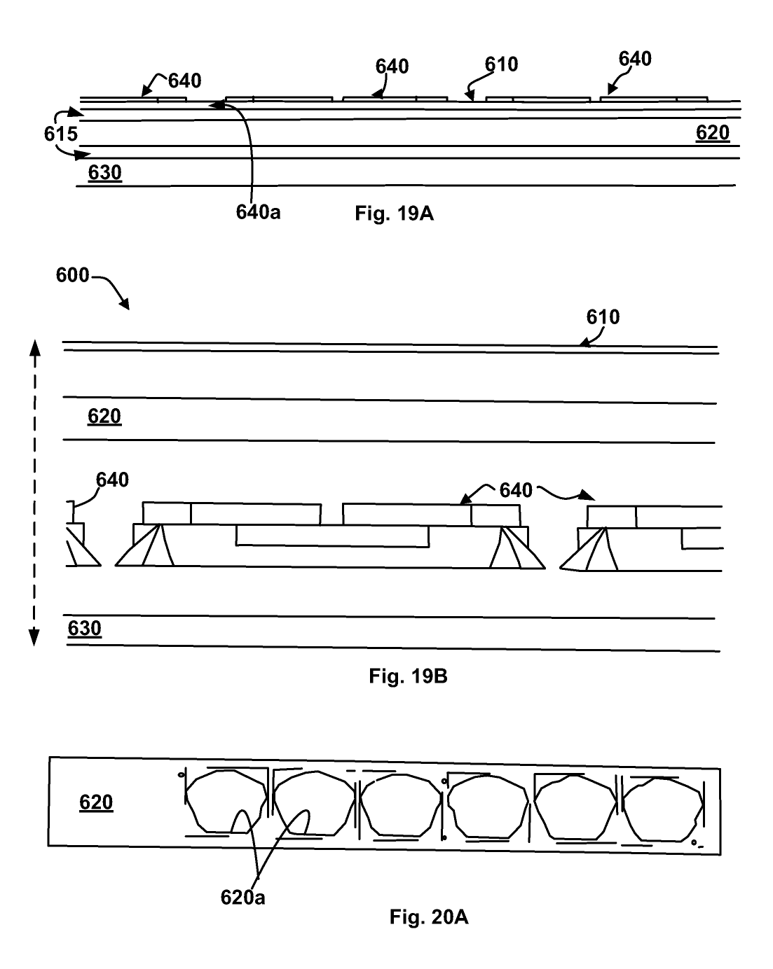

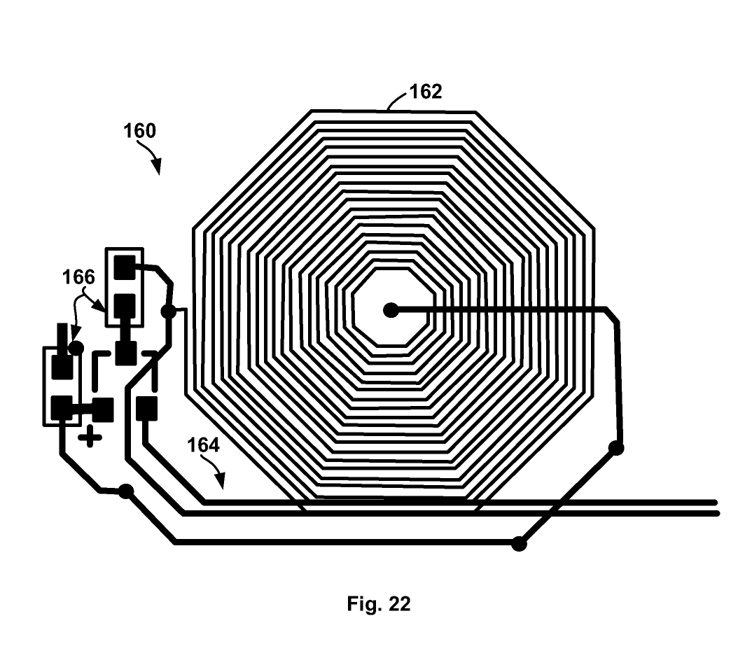

Referring now to FIGS. 19A-21C, there is shown another particular embodiment of an inductive touch key switch and assembly that can be used in connection with the inductive touch key switch system of the instant invention. In particular, the keyboard 600 includes a plurality of lighted key switches 640, wherein the key switch member 640 acts as both the light pipe for transmitting the light through the fascia or front panel 610, as well as the force translator for moving the target relative to the sensor coil. In particular, a back-lit key switch 640 is provided that includes lighted protrusions 640a, which form a light ring, and which pass through openings 610a in the opaque front panel 610. The key switch members 640 are held in place in a frame 620 disposed between the front panel 610 and a PCB 630. The frame 620 can be secured in place by the adhesive layers 615 located between the frame 620 and the PCB 630 and the frame 620 and the front panel 610. As with the prior embodiments, each key switch will be disposed in the frame over a corresponding sensor coil located on the PCB 630. The frame 620 can be aligned relative to the front panel 610 using the alignment pins 622, if desired.

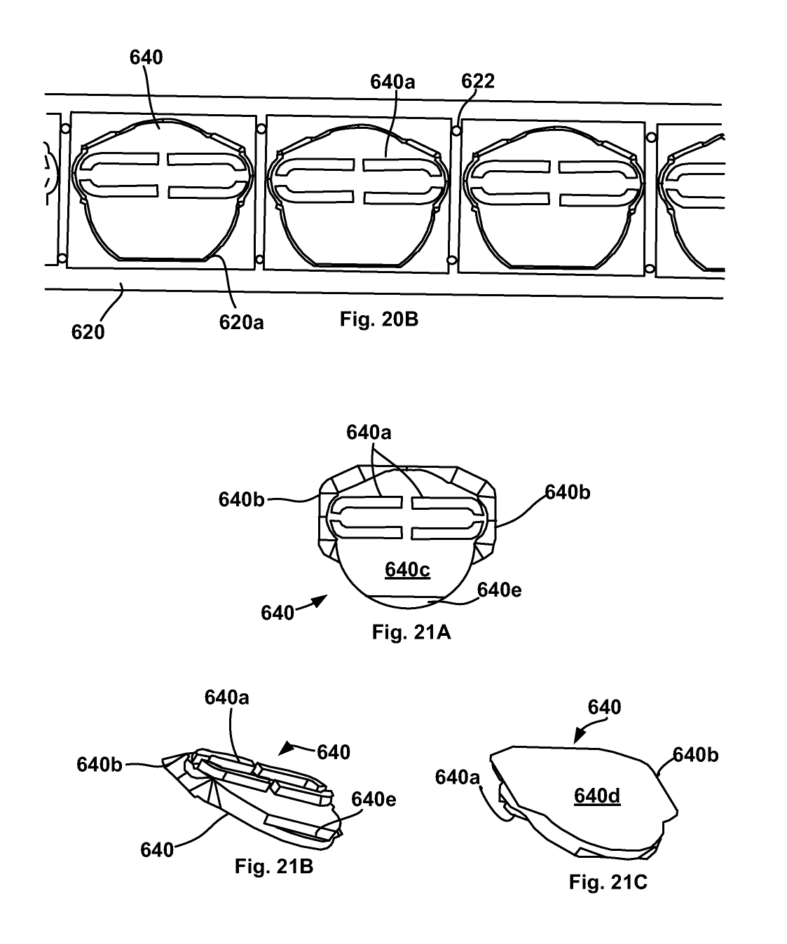

Each key switch member 640 is designed to mate with an opening 620a of the frame 620, with the light transmitting protrusions 640 passing through the front panel 610 of the assembly 600. A planar face 640c of the key switch member 640 is provided to support an adhesive layer and/or the front panel 610. The key switch member 640 is maintained in the frame (as shown in FIG. 20B) by the lugs 640b and notch 640e, which engage the back side of the frame 620, i.e., the side distal from the front face 610. A target (not shown in FIGS. 19-21) can be disposed directly on the rear face 640d of the key switch member 640 by heat stamping, adhesive and/or conductive printing. In one particular embodiment, the target is a piece of metallic foil adhered to the rear face 640d.

Upon assembly, each key switch member 640 is supported above a sensor coil by the frame 620 and/or an adhesive layer 612 (which does not pass under the portion of the key switch member including the target). The target on the rear face 640d of each key switch member 640 is disposed in the desired relationship with a sensor coil, as described elsewhere herein. As such, pressing the front face or fascia located over a key switch member 640 will result in flexure of the key switch member 640, thus changing the coupling between a target on the bottom face 640d of the key switch member 640 and the target.

It is important to note that the key switch assemblies described in connection with FIGS. 4-7, 12-15 and 19-20 can be used with the circuit shown in FIG. 3, but is not limited thereto. In particular, the improved inductive touch key switches described herein in connection with FIGS. 4-7, 12-15 and 19-20 can also be used with other inductive touch key switch driver circuits, including, but not limited to, the prior art driver circuit described in connection with FIG. 2.

Although the invention is illustrated and described herein as embodied in an inductive touch key switch, circuit and method, it is nevertheless not intended to be limited to only these details shown. For example, if desired, the inductive touch circuit of the instant invention can be modified to include a reference coil implemented in one key position of the keyboard. In such a configuration, the reference coil is used to aid in drift compensation as a standard reference with no key movement permitted. As can be seen, various modifications and structural changes may be made therein without departing from the spirit of the invention and within the scope and range of equivalents of the claims.

What is claimed is:

1. An inductive touch key switch system, comprising:
a plurality of inductive touch key switch assemblies;
each of said inductive touch key switch assemblies including a conductive target coupled to a sensor coil;
a plurality of driver circuits that produce a drive current;
each of said plurality of driver circuits including its own drive transistor; and
each of said plurality of driver circuits providing a drive current to only one of said plurality of inductive touch key switch assemblies.

2. The system of claim 1, wherein each of said plurality of driver circuits is located on the printed circuit board (PCB) local to the one inductive touch key switch assembly to which it provides a drive current.

3. The system of claim 1, wherein one lead connection of each sensor coil of each of the plurality of inductive touch key assemblies is tied directly to ground.

4. The system of claim 1, wherein at least one inductive touch key switch assembly of said plurality of inductive touch key switch assemblies includes a front panel portion, said conductive target being disposed adjacent to, but spaced away from, the sensor coil of said at least one inductive touch key switch assembly, said sensor coil being located on a PCB.

5. The system of claim 4, further including a frame disposed between said PCB and said front panel portion, wherein said frame includes a bridging section having a top surface adjacent to an under-surface of said front panel portion and a bottom surface facing towards the sensor coil, said conductive target being located proximal to said bottom surface of said bridging portion, whereby flexure of said front panel portion above said frame results in flexure of said bridging section and movement of at least a portion of said conductive target towards said sensor coil.

6. The system of claim 5, further including at least one light emitter located on said PCB and wherein at least a portion of said frame is fabricated from a light transmissive material, said light transmissive portion of said frame being located in optical communication with an emitting portion of said at least one light emitter.

7. The system of claim 5, wherein said target is affixed directly to said bottom surface of said bridging portion.

8. The system of claim 7, wherein said conductive target is affixed to said bottom surface of said bridging portion by at least one of heat stamping and printing.

9. The system of claim 7, wherein said frame further includes a boss portion depending from said bridging section, said conductive target being located in communication with said boss portion distal from said bridging section.

10. The system of claim 9, wherein said conductive target is affixed to the distal boss portion and floats above said sensor coil.

11. The system of claim 10, wherein said conductive target is a metal disc.

12. The system of claim 10, wherein said conductive target is one leaf of a multi-leaf target.

13. The system of claim 9, wherein said conductive target is a conductive cap mounted to said PCB, between said PCB and said boss portion, and over said sensor coil.

14. The system of claim 13, wherein said conductive cap is one of dome-shaped, box-shaped or a legged disc.

15. The system of claim 4, further including:
a second PCB disposed between the PCB having the sensor coil and said front panel portion;
a frame disposed between said second PCB and said front panel portion;
said frame including a bridging section having a top surface adjacent an under-surface of said front panel portion and a bottom surface facing towards said second PCB;
said frame further including a boss portion depending from the bottom surface of said bridging section, the distal portion of said boss portion being located adjacent to, or in communication with, a portion of a front surface of said second PCB;
said conductive target being located on a portion of a back surface of said second PCB beneath said boss portion, such that flexure of said front panel portion above said frame results in flexure of said bridging section, the force of which is transmitted by said boss portion to said second PCB, thus flexing said second PCB and changing the coupling of said conductive target with said sensor coil.

16. The system of claim 1, wherein at least one sensor coil is a multi-level sensor coil.

17. The system of claim 1, wherein each inductive touch key assembly includes a light transmissive key member supported by a frame, said target being disposed on a rear face of said light transmissive key member.

18. An inductive touch key switch assembly, comprising:
a user interface front panel portion;
a sensor coil disposed on a printed circuit board (PCB);
a conductive target disposed between said user interface front panel portion and said sensor coil;
a frame disposed between said PCB and said user interface front panel portion;
said frame including one of a key switch member or bridging section having a top surface adjacent to an under-surface of said user interface front panel portion and a bottom surface facing towards the sensor coil; and
said conductive target being located proximal to said bottom surface of said key switch member or bridging portion, whereby flexure of said front panel portion above said frame results in flexure of said key switch member or bridging section and movement of at least a portion of said conductive target towards said sensor coil.

19. The assembly of claim 18, wherein one lead connection of each sensor coil of each of the plurality of inductive touch key assemblies is tied directly to ground.

20. The assembly of claim 18, further including at least one light emitter located on said PCB and wherein at least a portion of said frame or said key switch member is fabricated from a light transmissive material, said light transmissive portion of said frame or key switch member being located in optical communication with an emitting portion of said at least one light emitter.

21. The assembly of claim 18, wherein said target is affixed directly to the bottom surface of a bridging portion.

22. The assembly of claim 21, wherein said conductive target is affixed to said bottom surface of said bridging portion by at least one of heat stamping and printing.

23. The assembly of claim 21, wherein said frame further includes a boss portion depending from said bridging section, said conductive target being located in communication with said boss portion distal from said bridging section.

24. The assembly of claim 23, wherein said conductive target is affixed to the distal boss portion and floats above said sensor coil.

25. The assembly of claim 24, wherein said conductive target is a metal disc.

26. The assembly of claim 24, wherein said conductive target is one leaf of a multi-leaf target.

27. The assembly of claim 23, wherein said conductive target is a conductive cap mounted to said PCB, between said PCB and said boss portion, and over said sensor coil.

28. The assembly of claim 27, wherein said conductive cap is one of dome-shaped, box-shaped or a legged disc.

29. The assembly of claim 18, wherein said sensor coil includes a first set of turns that turn in a first direction and a second set of turns that turn in a second direction, said second direction being counter to said first direction, said second set of turns surrounding said first set of turns.

30. The assembly of claim 18, wherein said sensor coil includes a first set of turns, said assembly further including at least one additional turn located outside of the first set of turns, said at least one additional turn being shorted to a reference potential.

31. The assembly of claim 18, wherein at least one sensor coil is a multi-level sensor coil.

32. An inductive touch key switch assembly, comprising:
a user interface front panel portion;
a sensor coil disposed on a first printed circuit board (PCB);
a conductive target disposed between said user interface front panel portion and said sensor coil;
a second PCB disposed between the first PCB having the sensor coil and said user interface front panel portion;
a frame disposed between said second PCB and said user interface front panel portion;
said frame including a bridging section having a top surface adjacent to an under-surface of said user interface front panel portion and a bottom surface facing an upper surface of said second PCB;
said frame further including a boss portion depending from the bottom surface of said bridging section, the distal portion of said boss portion being located adjacent to, or in communication with, a portion of the upper surface of said second PCB; and
said conductive target being located on a portion of a lower surface of said second PCB, beneath said boss portion, such that flexure of said user interface front panel portion above said frame results in flexure of said bridging section, the force of which is transmitted by said boss portion to said second PCB, thus flexing said second PCB and changing the coupling of said conductive target with said sensor coil.

33. The assembly of claim 32, wherein said conductive target is affixed to said lower surface of said second PCB by at least one of heat stamping and printing.

34. The assembly of claim 32, wherein one lead connection of each sensor coil of each of the plurality of inductive touch key assemblies is tied directly to ground.

35. The assembly of claim 32, further including at least one light emitter located on said PCB and wherein at least a portion of said frame is fabricated from a light transmissive material, said light transmissive portion of said frame being located in optical communication with an emitting portion of said at least one light emitter.
